(19) United States
(12) Patent Application Publication
(10) Pub. No.: US 2008/0294695 A1
(43) Pub. Date: Nov. 27, 2008

(54) Use of XML for a modular system used to study label free biomolecular interactions

(75) Inventors: John Lawrence Ervin, San Diego, CA (US); Hus Tigli, La Jolla, CA (US)

Correspondence Address: TREX ENTERPRISES CORP., 10455 PACIFIC COURT, SAN DIEGO, CA, 92121, US

(73) Assignee: Trex Enterprises Corp.

(21) Appl. No.: 12/221,121

(22) Filed: Jul. 30, 2008

Related U.S. Application Data
(63) Continuation-in-part of application No. 11/180,349, filed on Jul. 13, 2005.
Application No. 11/180,349 is a continuation-in-part of application No. 10/631,592, filed on Jul. 30, 2003.
Application No. 10/631,592 is a continuation-in-part of application No. 10/616,251, filed on Jul. 8, 2003.
(60) Provisional application No. 60/962,652, filed on Jul. 30, 2007.
(60) Provisional application No. 60/962,616, filed on Jul. 30, 2007.
(60) Provisional application No. 60/962,664, filed on Jul. 30, 2007.
(60) Provisional application No. 60/962,756, filed on Jul. 30, 2007.
(60) Provisional application No. 60/962,675, filed on Jul. 30, 2007.
(60) Provisional application No. 60/962,669, filed on Jul. 30, 2007.
(60) Provisional application No. 60/962,644, filed on Jul. 30, 2007.
(60) Provisional application No. 61/127,910, filed on May 15, 2008.

(51) Int. Cl. G06F 17/00

(52) U.S. Cl. 707/104.1; 707/E17.127

(57) ABSTRACT

The use of XML in the context of a system of instrument modules used to study label free binding interactions. This includes provisions for computer to instrument communication using XML, intramodule communication using XML, a data format in XML and for automated firmware testing using XML.

### CROSS-REFERENCE TO RELATED APPLICATIONS

This application claims the benefit of provisional patent applications Ser. Nos. 60/962,652, 60/962,616, 60/962,664, 60/962,756, 60/962,675, 60/962,669 and 60/962,644 all filed Jul. 30,2007 and provisional patent application Ser. No. 61/127,910, filed May 15,2008 and is a continuation in part of Ser. No. 11/180,349 filed Jul. 13,2005, Ser. No. 10/631,592 filed Jul. 30,2003 and Ser. No. 10/616,251 filed Jul. 8,2003.

### FIELD OF INVENTION

This invention relates to computer systems and in particular to computer systems used to drive systems that acquire and analyze large amounts of data produced by optical sensors such as optical biosensors.

### BACKGROUND OF THE INVENTION

### Optical Biosensors

An optical biosensor is an optical sensor that incorporates a biological sensing element. In recent years optical biosensors have become widely used for sensitive molecular binding measurements. To study interactions of proteins with other biomolecules one may generally use labeled or label-free methods. For these methods a first molecule of interest (the receptor) is immobilized onto a surface. An interaction is monitored by then introducing additional molecules (the targets) and detecting whether they in fact bind to the receptor. When using labels to monitor these interactions a fluorescent, colorimetric or some other signal is generated by an additional molecule or moiety that is attached to the target or receptor which gives a signal when the interaction takes place. This so called label (or tag) is present only to detect the interaction and is not part of the interaction of interest per se.

In label free binding, on the other hand, the receptor and target binding are monitored directly using untagged biomolecules. A variety of technologies exist in the art to detect binding without labels including surface plasmon resonance (SPR) and white light interferometery using porous silicon. In addition to the variety of technologies which exist to monitor label free binding events, there are a variety of instrument architectures which can used. These include plate readers and flow cells. In the case of plate readers a well plate (or micro well plate or micro titer plate) is used to house the biochips and fluids which are used for the label free binding studies. This allows for parallel analyses of several types of data. Alternatively flow cells house biochips in, typically, a microfluidic cell which routes fluid over the region of the biochip where the binding interaction takes place.

When acquiring and analyzing data of this sort there are a number of steps which are performed for the data analysis (the data method) on a number of channels (be those channels, flow cells or wells in a well plate). A file format which captures the full gamut of what a user of the analytical instrument might want to do must incorporate flexibility in acquisition and in analysis.

### Surface Plasmon Resonance

An optical biosensor technique that has gained increasing importance over the last decade is the surface plasmon resonance (SPR) technique. This technique involves the measurement of light reflected into a narrow range of angles from a front side of a very thin metal film producing changes in an evanescent wave that penetrates the metal film. Ligands and analytes are located in the region of the evanescent wave on the backside of the metal film. Binding and disassociation actions between the ligands and analytes can be measured by monitoring the reflected light in real time. These SPR sensors are typically very expensive. As a result, the technique is impractical for many applications.

### Resonant Mirror

Another optical biosensor is known as a resonant mirror system, also relies on changes in a penetrating evanescent wave. This system is similar to SPR and, like it, binding reactions between receptors and analytes in a region extremely close to the back side of a special mirror (referred to as a resonant mirror) can be analyzed by examining light reflected when a laser beam directed at the mirror is repeatedly swept through an arc of specific angles. Like SPR sensors, resonant mirror systems are expensive and impractical for many applications.

### Thin Films

It is well known that monochromic light from a point source reflected from both surfaces of a film only a few wavelengths thick produces interference fringes and that white light reflected from a point source produces spectral patterns that depend on the direction of the incident light and the index of refraction of film material. (See “Optics” by Eugene Hecht and Alfred Zajac, pg. 295-309, Addison-Wesley, 1979.)

### Porous Silicon Layers

U.S. Pat. No. 6,248,539 (incorporated herein by reference) discloses techniques for making porous silicon and an optical resonance technique that utilizes a very thin porous silicon layer within which binding reactions between ligands and analytes take place. The association and disassociation of molecular interactions affects the index of refraction within the thin porous silicon layer. Light reflected from the thin film produces interference patterns that can be monitored with a CCD detector array. The extent of binding can be determined from change in the spectral pattern.

### Kinetic Binding Measurements

Kinetic binding measurements involve the measurement of rates of association (molecular binding) and disassociation. Analyte molecules are introduced to ligand molecules producing binding and disassociation interactions between the analyte molecules and the ligand molecules. Association occurs at a characteristic rate [A][B]kₒₙ that depends on the strength of the binding interaction kₒₙ and the ligand topologies, as well as the concentrations [A] and [B] of the analyte molecules A and ligand molecules B, respectively. Binding events are usually followed by a disassociation event, occurring at a characteristic rate [A][B]k_{off} that also depends on the strength of the binding interaction. Measurements of rate constants kₒₙ and k_{off} for specific molecular interactions are important for understanding detailed structures and functions of protein molecules. In addition to the optical biosensors discussed above, scientists perform kinetic binding measurements using other separations methods on solid surfaces combined with expensive detection methods (such as capillary liquid chromatography/mass spectrometry) or solution-phase assays. These methods suffer from disadvantages of cost, the need for expertise, imprecision and other factors.

### Separations-Based Measurements

More recently, optical biosensors have been used as an alternative to conventional separations-based instrumentation and other methods. Most separations-based techniques have typically included 1) liquid chromatography, flow-through techniques involving immobilization of capture molecules on packed beads that allow for the separation of target molecules from a solution and subsequent elution under different chemical or other conditions to enable detection; 2) electrophoresis, a separations technique in which molecules are detected based on their charge-to-mass ratio; and 3) immunoassays, separations based on the immune response of antigens to antibodies. These separations methods involve a variety of detection techniques, including ultraviolet absorbance, fluorescence and even mass spectrometry. The format also lends itself to measure of concentration and for non-quantitative on/off detection assays.

What is needed is a data format for efficiently analyzing large amounts of data accumulated making molecular binding measurements.

### XML

Extensible markup language (XML) is a standard for describing data in an extensible way using a text based file format with markup. The content permissible in any particular XML file is determined by a second XML file called the schema. This schema file rigorously prescribes what may be in a file with regard to content, content order, data type and data limits. A schema for a particular application is often called the XML application.

### SUMMARY OF THE INVENTION

The present invention provides the use of XML in the context of a system of instrument modules used to study label free binding interactions. This includes provisions for computer to instrument communication using XML, intramodule communication using XML, a data format in XML and for automated firmware testing using XML. The several schema for this XML based communication are optimized to allow for data from a variety of analytical instrumentation architectures, in particular from a well plate reader and from flow cell instrument architectures. A preferred embodiment of the invention is designed for use in the analysis of label free binding studies of biomolecules.

### BRIEF DESCRIPTION OF THE DRAWINGS

FIG. 1 Shows how XML schema are used to validate the intermodule communication

FIG. 2 Shows how a three XML file set are used to automate firmware testing

### DETAILED DESCRIPTION OF PREFERRED EMBODIMENTS

A preferred embodiment of the present invention is designed for use to analyze data accumulated with an optical biosensor described in parent patent applications Ser. No. 11/180,349 filed Jul. 13,2005, Ser. No. 10/631,592 filed Jul. 30,2003 and Ser. No. 10/616,251 filed Jul. 8,2003 and Ser. No. ______ entitled “Optical Sensor and Methods for Measuring Molecular Binding Interactions” which is being filed simultaneously with this application. All of the above applications are incorporated herein by reference. The present invention uses an XML for intermodule communication, data saving and analysis and for automated firmware testing. The schema for that language is optimized to allow for data from a variety of analytical instrumentation architectures, in particular from a well plate reader and from a flow cell architectures. When acquiring and analyzing data with the type of instruments described in the parent applications, there are a number of steps which are performed for the data analysis (the data method) on a number of channels (be those channels, flow cells or wells in a well plate). A file format which captures the full gamut of what a user of the analytical instrument might want to do must incorporate flexibility in acquisition and in analysis. An XML format allows this to occur with careful design of the schema. Using the element structure inherent in XML allows wells and or flow cells to be arbitrarily identified with certain functions in the analysis.

For instance, in acquiring label free binding data, a user may select a range of receptor concentrations. Typically this will include zero receptor concentration (zero point reading). Where this zero point reading is (which flow cell, which well plate) may use an arbitrary flow cell, or arbitrary well plate position. It may come from a different data file on a different day. Finally the zero point may need to be arbitrary assigned or reassigned a zero point reading flag to a particular well plate.

Likewise a typical study will include a range of target concentrations. This range will also typically include a zero target concentration (blank). This blank may also need to be reassigned, may come from a different data file, or some arbitrary well position.

Those well positions or flow cells which are not zero point readings or blanks are typically referenced to the zero point readings and blanks. Therefore a fully flexible file format should have a cross referencing structure which may be updated as more data becomes available. Likewise multiple files should be able to be included to fully represent what the researcher is studying.

### DETAILED DESCRIPTION OF PREFERRED EMBODIMENTS

The use of XML invented by the applicants here has three parts. First is the use for intramodule communication. Second is the use of automated firmware testing and third is the flexible data format that encompasses multiple formats in a single simplified schema.

### Intramodule Communication

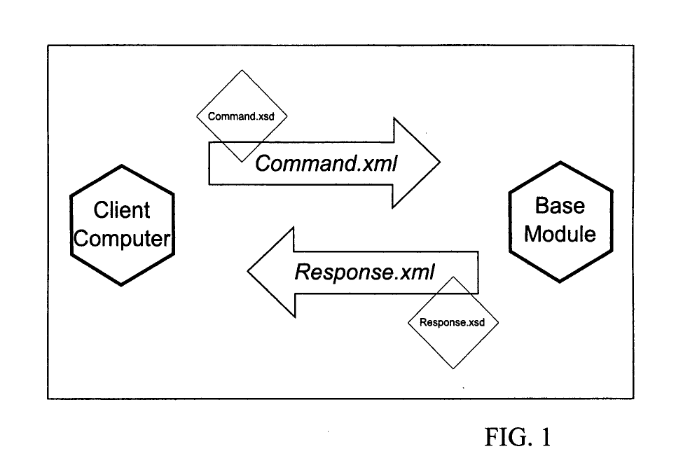

Preferred embodiments of the present invention includes a communication protocol never before utilized for this type of optical sensor. The protocol provides biomolecular interaction researchers with an easy to understand XML format for inter-module communication. The communication protocol consists of three main parts. Two of these are the schema describing the possible commands the instrument system understands and the schema describing the possible responses of the system. The third part of the protocol is based on a scheme used to describe the actual configuration of the fluidics module as described above. Using these schema, communication is validated in both directions. As can be seen in the attached FIG. 1 the client computer forms an XML command. Before it is sent to the base module, it is validated against the Command.xsd schema to see if the command is in fact part of the vocabulary understood by the base system. The base then receives the command, processes it and forms a response. The response is then validated against the Response.xsd schema to see if it is in fact valid before it is sent to the client.

As a specific example consider the command to turn on the pump in the fluidics unit. This command goes from the client computer through TCP/IP to the base unit. It might look like this:

```
<SKCommand>
    <PumpSet>
        <direction>forward</direction>
        <rate>20</rate>
    </PumpSet>
</SKCommand>
```

After the command is generated, it is validated against the schema (SKCommand.xsd) client side to see if the command is in fact a valid one. After it is shown that it is valid the command it is sent to the base unit through TCP/IP. The base unit recognizes that this command is part of the fluidics schema. Given that, the base will not act on the command. Rather the command is passed from the base to the fluidics box. The fluidics box then generates the response to this:

```
<SKResponse>
    <Pump>
        <direction>forward</direction>
        <rate>20</rate>
    </Pump>
</SKResponse>
```

This is then passed from the fluidics box to the base and the base passes this through to the client. The client then validates the response against the response schema (SKResponse.xsd). XML used to form the heart of the communication protocol for a modular label free binding instrument system is not known in the art.

As schema can be written for each module the base can be programmed to easily pass through the commands from the client computer to the appropriate module. That is, the base need not understand how to process commands for the fluidics box as it can simply pass them through.

The schema files describe the Command and Response vocabulary in such a way that an arbitrary number of commands may be passed in any packet. For instance the pump may be set the same time as the temperature—only a single TCP/IP step is necessary.

```
<SKCommand>
    <PumpSet>
        <direction>forward</direction>
        <rate>20</rate>
    </PumpSet>
    <TempSet>37.0</TempSet>
</SKCommand>
```

In which case the <PumpSet> command is routed to the fluidics box where it is handled while, at the same time the temperature command is handled directly in the base. Here the response will be.

```
<SKResponse>
    <Pump>
        <direction>forward</direction>
        <rate>20</rate>
    </Pump>
    <TempSetpoint>37.0</TempSetpoint>
</SKResponse>
```

The new scheme for modular instrumentation control presented here eases the programming for a multimodule instrument system and allows for thorough validation on the instrument and response side. Significantly, the applicants have devised a schema using XML to automate the testing of the command and response vocabulary.

### Automated Firmware Testing

The present embodiment includes a new way of using the Command.xsd and Response.xsd schema for automated testing of the firmware running on the instrument system. Here it needs to be shown that the full vocabulary expected by the command and response system is in fact understood and properly handled by the system. In order to do this a very large number of tests are generated automatically.

In the preferred embodiment this is accomplished by combining the command and response schemas with a third xml file which determines the correct relationship between the response and the command. As shown in FIG. 1 a ResponseToCommand.xml file describes these expected relationship. This file, in combination with the two schema, is read to automatically generate a firmware test, where each test is a test.xml test command and test.xsd response schema.

For the commands above there is a schema for both the command and the response. In the case of the command the command schema describes the syntax of the elements <PumpSet> and <TempSet> and in the case of the response this describes the syntax of the elements <Pump> and <TempSetpoint>. In order to automate the testing of these functions, an xml file called (ResponseToCommand.xml) exists. This file documents the relationship between the given command and the expected response. In the case above it would be.

```
<ResponseToCommand>
    <Relationship ind=”1”>
        <Command>PumpSet</Command>
        <Response>Pump</Response>
    </Relationship>
    <Relationship ind=”2”>
        <Command>TempSet</Command>
        <Response>TempSetpoint</Response>
    </Relationship>
</ResponseToCommand>
```

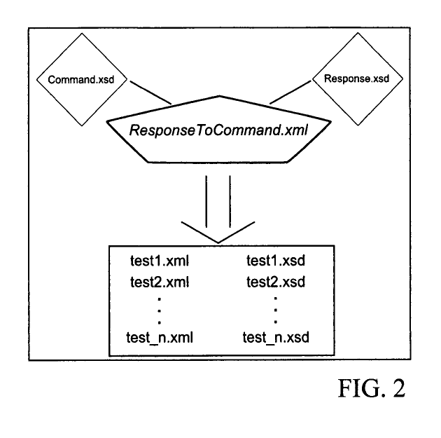

Using this file a series of tests may be automatically generated to test the firmware on the modular system (see FIG. 2). For example, it is clear that <PumpSet> is a valid command per the command schema. However, per the response schema, the response <Pump> may or may not be there. If <PumpSet> were not sent with the command packet then <Pump> would not need to be there in the response.

However, it is clear that the client does expect a response to <PumpSet> (namely the <Pump> element). To test the vitality of the firmware the ResponseToCommand shows that relationship. Now, using this file the test for the <PumpSet> to <Pump> relationship is formed. This test takes the form of two xml files. One is the command itself where the values of <direction> and <rate> are chosen based on the datatype described in the command schema:

```
<SKCommand>
    <PumpSet>
        <direction>forward</direction>
        <rate>20</rate>
    </PumpSet>
</SKCommand>
```

The second file generated is a separate schema file:

```
<xs:schema xmlns:xs=“http://www.w3.org/2001/XMLSchema”
xml:lang=“en-us” version=“1.0”>
  <xs:element name=“SKResponse” type=“SKResponseType” />
  <xs:complexType name=“SKResponseType”>
  <xs:all>
    <xs:element name=“Pump” type=“PumpType” minOccurs=“1” />
  </xs:all>
  </xs:complexType>
  <xs:complexType name=“PumpType”>
  <xs:all>
    <xs:element name=“direction” type=“directionType”
    minOccurs=“1” />
    <xs:element name=“rate” type=“rateType” minOccurs=“1” />
  </xs:all>
  </xs:complexType>
  <xs:simpleType name=“rateType”>
      <xs:restriction base=“xs:unsignedInt”>
        <xs:minInclusive value=“20”/>
        <xs:maxInclusive value=“20”/>
      </xs:restriction>
  </xs:simpleType>
  <xs:simpleType name=“directionType”>
      <xs:restriction base=“xs:string”>
        <xs:enumeration value=“forward” />
      </xs:restriction>
  </xs:simpleType>
</xs:schema>
```

Also, the readability of xml—as compared to binary or other proprietary forms of instrument communication—allows users of the instrument set to readily develop custom routines not foreseen in the available instrument software running on the client PC. That is, as the schema are published for the users of the machine, those users may readily adopt the machine for their own use using existing xml tools.

### Flexible Data Format

The preferred embodiment of this file format is an XML application fully defined by the attached schema file below. This schema allows for the description of the data acquisition method, the data itself and the analysis of that data. Significantly, this single schema definition allows the same XML application to be used for data from different formats of instruments namely here a plate reader and a flow cell. Additionally, the analysis steps that are performed are themselves captured in the application. Being an extensible format additional analysis steps may also be added.

What is claimed is:

1. A method to store biomolecular interaction data comprising:
A) Using an extensible markup language (XML) file
B) Having a XML schema definition of that file

2. The method as in claim 1 wherein the same file format is used to describe either flow cell data, well plate data or both types of data.

3. The method as in claim 1 wherein the same file format is used to describe data acquisition methods, the data itself and the data analysis.

4. A method to use XML schema to build control languages for instrumentation comprising
A) An XML schema (which may be one or several files) which determines the command vocabulary the instrument understands.
B) An XML schema (which may be one or several files) which determines the response vocabulary the instrument returns.
C) An XML file that establishes the relationship between the command and response vocabulary.

5. The method as in claim 5 wherein the three components are used to generate automatic tests that are used to test the instrument control software.

6. The method as in claim 5 wherein the instrument is composed of several communicating modules.

7. The method as in claim 6 wherein one or several schema (each of which may be one or several files) are used to validate and map commands between the modules.
